(19) United States
(12) Patent Application Publication
(10) Pub. No.: US 2025/0075345 A1
(43) Pub. Date: Mar. 6, 2025

(54) HEAT RECOVERY SYSTEM FOR HYDROGEN PRODUCTION WITH SOLID OXIDE ELECTROLYSIS CELL

(71) Applicant: JIANGSU UNIVERSITY OF SCIENCE AND TECHNOLOGY, Jiangsu (CN)

(72) Inventors: Wei KONG, Jiangsu (CN); Zhaoxiang JI, Jiangsu (CN); Zidong YU, Jiangsu (CN); Yanni GU, Jiangsu (CN); ARKADII PROSKURIN, Jiangsu (CN)

(73) Assignee: JIANGSU UNIVERSITY OF SCIENCE AND TECHNOLOGY, Jiangsu (CN)

(21) Appl. No.: 18/557,595

(22) PCT Filed: Oct. 25, 2022
(86) PCT No.: PCT/CN2022/127367

§ 371 Date: Oct. 27, 2023

(30) Foreign Application Priority Data
Nov. 29, 2021 (CN) 202111432321.5

(51) Int. Cl. C25B 9/67; C25B 1/04; C25B 15/021; C25B 15/08

(52) U.S. Cl. CPC C25B 9/67; C25B 1/04; C25B 15/021; C25B 15/081; C25B 15/083

(57) ABSTRACT

A heat recovery system for hydrogen production with a solid oxide electrolysis cell, including a water storage tank, a solar cell panel, a low-temperature metal hydrogen storage tank, an evaporator, a high-temperature metal hydrogen storage tank, a heat exchanger, a solid oxide electrolysis cell, a separator, and a reactor is provided. After water in the water storage tank sequentially passes through the solar cell panel, the low-temperature metal hydrogen storage tank, the evaporator, the high-temperature metal hydrogen storage tank, and the heat exchanger for multi-stage heat exchange, water vapor reaching the working temperature enters the solid oxide electrolysis cell. The hydrogen generated after electrochemical reaction and unused water vapor flow out from the solid oxide electrolysis cell, firstly exchange heat with to-be-reacted water vapor through the heat exchanger and then enter the separator.

### TECHNICAL FIELD

The present disclosure relates to a heat recovery system for hydrogen production with a solid oxide electrolysis cell.

### DESCRIPTION OF RELATED ART

Carbon dioxide emissions from fossil fuel energy consumption have brought climate disasters such as climate warming and glaciers melting, resulting in that climate change mitigation becomes one of the greatest challenges facing human beings in current era. To cope with this challenge, a promising solution is proposed, i.e., replacing fossil fuels with renewable energy sources such as wind energy and solar energy. However, these energy sources have the properties of randomness, intermittent, volatility, and anti-peaking, and when the electrical energy converted by these energy sources exceeds 20-30% of the grid capacity, it will lead to grid instability, resulting in that the integration of renewable energy and power grid has a serious impact on stable operation of the power grid. Therefore, the full utilization of renewable energy sources requires further development of energy conversion and storage technologies. The application of water electrolysis technology will allow us to overcome these limitations and enable the storage of renewable energy sources in the form of fuels and chemicals. However, in view of the difficulty in storing hydrogen, the hydrogen produced by water electrolysis is reacted with carbon dioxide to generate methanol, which can not only reduce carbon emissions, advance carbon neutralization and carbon peaking, but also can convert hydrogen into methanol that is easier to store and transport.

At present, water electrolysis technologies include proton membrane electrolysis, alkaline electrolysis, and solid oxide cell electrolysis, where solid oxide cell electrolysis has the highest electrolysis efficiency, but since its working temperature is required to reach 800 degrees Celsius, how to efficiently heat normal temperature water to the working temperature of the solid oxide electrolysis cell is vital for the application of this technology. If the traditional electric heating or fuel heating is used, energy consumption of the whole system will be greatly increased.

### SUMMARY

Objective of the disclosure: An objective of the present disclosure is to provide a heat recovery system for hydrogen production with a solid oxide electrolysis cell that can not only heat water by using waste heat in each part of the system, but also can realize reasonable storage of the produced hydrogen.

Technical solution: The heat recovery system for hydrogen production with a solid oxide electrolysis cell according to the present disclosure includes a water storage tank, a solar cell panel, a low-temperature metal hydrogen storage tank, an evaporator, a high-temperature metal hydrogen storage tank, a heat exchanger, a solid oxide electrolysis cell, a separator, and a reactor. After water in the water storage tank sequentially passes through the solar cell panel, the low-temperature metal hydrogen storage tank, the evaporator, the high-temperature metal hydrogen storage tank, and the heat exchanger for multi-stage heat exchange, water vapor reaching the working temperature enters the solid oxide electrolysis cell. The hydrogen generated after electrochemical reaction and unused water vapor flow out from a cathode product outlet of the solid oxide electrolysis cell, firstly exchange heat with to-be-reacted water vapor through the heat exchanger and then enter the separator. One hydrogen outlet I of the separator is connected with the low-temperature metal hydrogen storage tank and the high-temperature metal hydrogen storage tank, and heat released in the hydrogen storage process of the hydrogen storage tank is used to heat water. The other hydrogen outlet II of the separator is connected with the reactor, hydrogen and carbon dioxide are reacted in the reactor to generate methane, and reaction heat of methane production is conveyed to the evaporator to heat the water. A water vapor outlet of the separator is connected with the water storage tank.

The low-temperature metal hydrogen storage tank includes a heat exchange cavity I and a hydrogen confluence chamber I, where the heat exchange cavity I is provided with a plurality of partition plates I arranged in parallel, the heat exchange cavity I is further provided with a liquid water inlet and a liquid water outlet, and the plurality of parallel partition plates I form a liquid water baffle flow channel in the heat exchange cavity I. A hydrogen inlet I is arranged on the hydrogen confluence chamber I, the hydrogen confluence chamber I is communicated with a plurality of metal hydrogen storage microtubes, and the metal hydrogen storage microtubes penetrate the entire heat exchange cavity I and are filled with hydrogen storage materials.

The metal hydrogen storage microtube is a sandwich type casing, including an outer tube and an inner tube closed at one end thereof, where the outer sidewall of the inner tube is longitudinally provided with a plurality of through holes, a cavity between the inner tube and the outer tube is filled with a low-temperature hydrogen storage material, the low-temperature hydrogen storage material is a hydrogen storage material of LaNi5 series, and the exothermic temperature is 60-70° C.

The inner diameter of the metal hydrogen storage microtube (an outer tube) is 6 cm, and the outer diameter of an inner mass transfer circular tube (an inner tube) is 3 cm.

The high-temperature metal hydrogen storage tank includes a heat exchange cavity II and a hydrogen confluence chamber II, where the heat exchange cavity II is provided with a plurality of partition plates II arranged in parallel, the heat exchange cavity II is further provided with a water vapor inlet and a water vapor outlet, and the plurality of parallel partition plates II partition the heat exchange chamber II into a plurality of heat exchange chambers. A hydrogen inlet II is arranged on the hydrogen confluence chamber II, the hydrogen confluence chamber II is communicated with a plurality of metal hydrogen storage tubes, and the outer wall of each metal hydrogen storage tube is provided with a plurality of cylindrical ribs that are capable to strengthen the heat exchange between the flowing gas and the tube wall. The plurality of metal hydrogen storage tubes penetrate the entire heat exchange cavity II, and the metal hydrogen storage tubes are filled with high-temperature hydrogen storage materials. The metal hydrogen storage tube and the metal hydrogen storage microtube have the same structure, both of which are sandwich type casings, but the cavity between the inner tube and the outer tube of the metal hydrogen storage tube is filled with a high-temperature hydrogen storage material, the high-temperature hydrogen storage material is of MgH₂ series, and the exothermic temperature is 330-380° C.

The evaporator includes a heat exchange cavity, the heat exchange cavity is provided with a cold fluid inlet and a water vapor outlet, and a plurality of porous water absorption layers (similar to a sponge structure) are arranged in the longitudinal direction of the heat exchange cavity.

The evaporator further includes a confluence area and a collector area located in the heat exchange cavity, the inlet of the confluence area is connected with an external reactor through a hot fluid inlet, the outlet of the confluence area is connected with the inlet of the collector area through a plurality of heat flow pipes, and the outlet of the collector area is connected to an external methanol storage tank through a hot fluid outlet. The heat flow pipes are arranged in the heat exchange cavity along the lateral direction, a small amount of water is sucked into the porous water absorption layer under the action of capillary force, and the porous water absorption layer exchanges heat with a plurality of heat flow pipes.

The reactor includes a gas mixing chamber and a reaction chamber, where the reaction chamber is provided with a multi-layer reaction zone, the reaction zone is a porous catalyst layer, the gas mixing chamber is composed of a plurality of communicated and concentric annular flow channels, a hydrogen inlet and a carbon dioxide inlet are communicated with a central chamber of the annular flow channel, a communication hole is formed at the bottom of the outermost annular flow channel, and the annular flow channel is communicated with the reaction chamber through the communication hole. After full mixing, the mixed gas flows along the annular flow channel from an inner ring to an outer ring and then enters the reaction chamber from the communication hole, the mixed gas of hydrogen and carbon dioxide reacts at the porous catalyst layer, and the methane generated after the reaction at the multi-layer catalyst layer flows out from a methanol outlet of the reaction chamber.

A methanol content sensor is arranged at the methanol outlet.

Beneficial effects: The system of the present disclosure is capable to solve the problem that when a solid oxide electrolysis cell is used for water electrolysis, a huge amount of energy is consumed due to use of external thermal energy to heat water to a working temperature of 800° C. Through efficient and reasonable utilization of the waste heat in various links to heat normal temperature water to the working temperature heat normal temperature water to the working temperature 800° C. of the solid oxide electrolysis cell, the present disclosure can achieve the effect of energy saving, and effectively store the generated hydrogen. Finally, the generated hydrogen is reacted with carbon dioxide to achieve the goal of carbon dioxide emission reduction.

### BRIEF DESCRIPTION OF THE DRAWINGS

FIG. 1 is a schematic diagram of the system of the present disclosure.

FIG. 2 is a schematic diagram of the structure of a low-temperature metal hydrogen storage tank.

FIG. 3 is a schematic diagram of the structure of a metal hydrogen storage microtube.

FIG. 4 is a schematic diagram of the structure of a high-temperature metal hydrogen storage tank.

FIG. 5 is a schematic diagram of the structure of an evaporator.

FIG. 6 is a schematic diagram of the structure of a reactor.

FIG. 7 is a top view of a gas mixing chamber.

### DESCRIPTION OF THE EMBODIMENTS

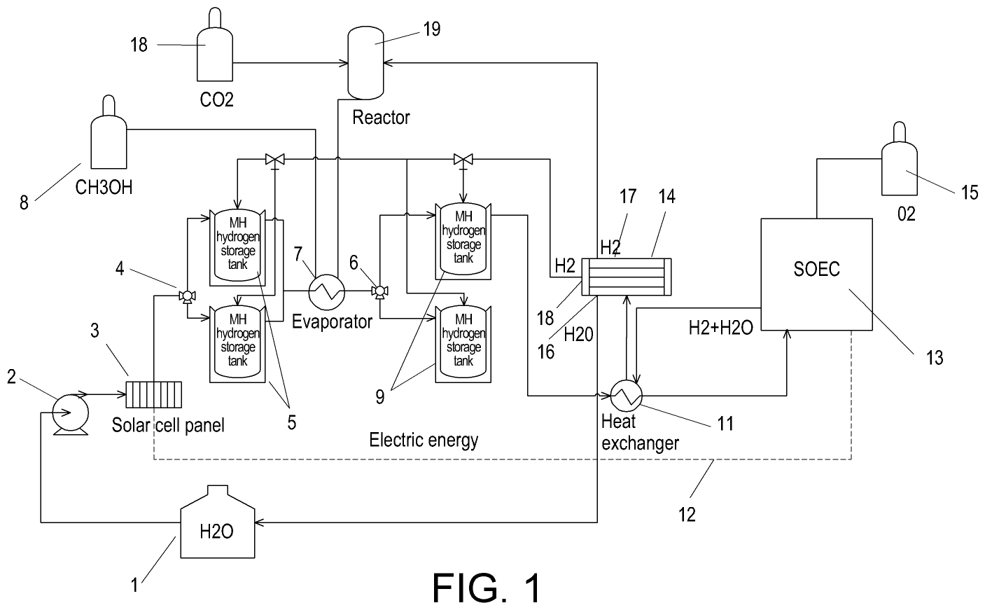

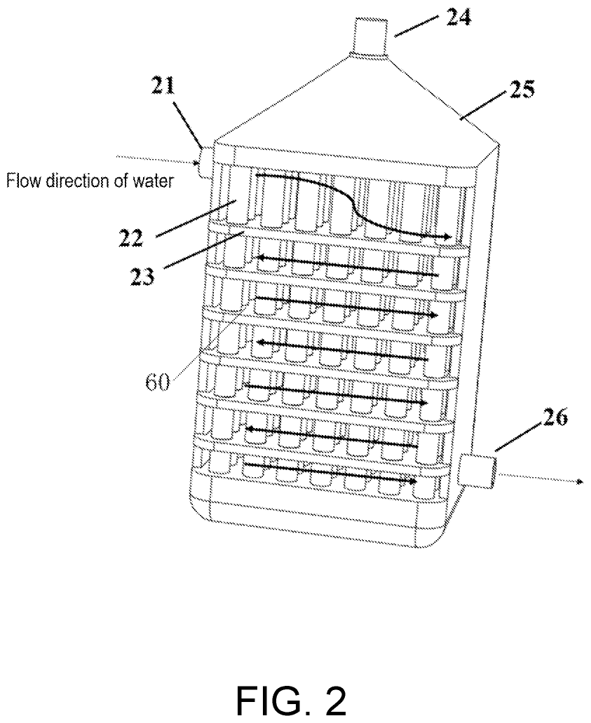

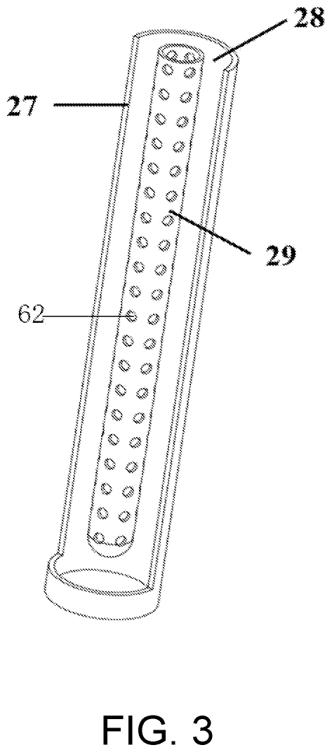

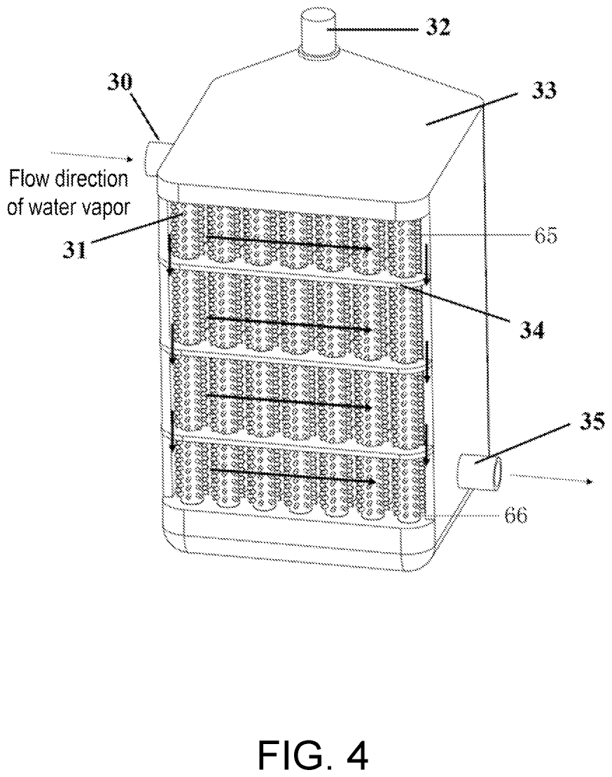

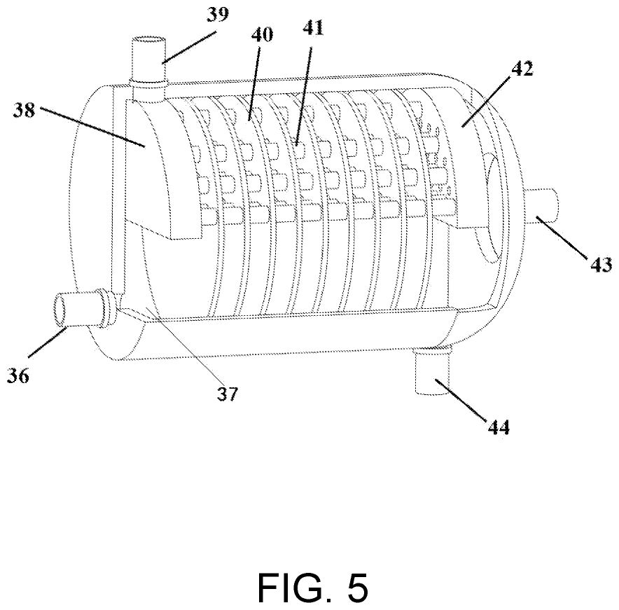

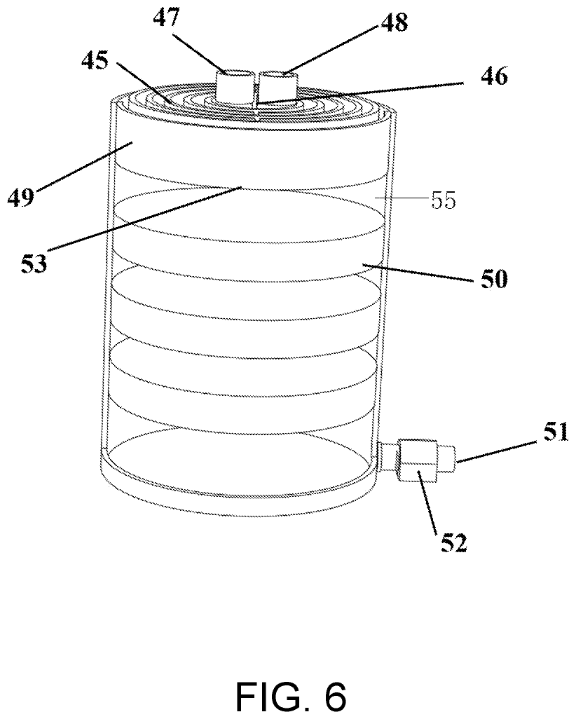

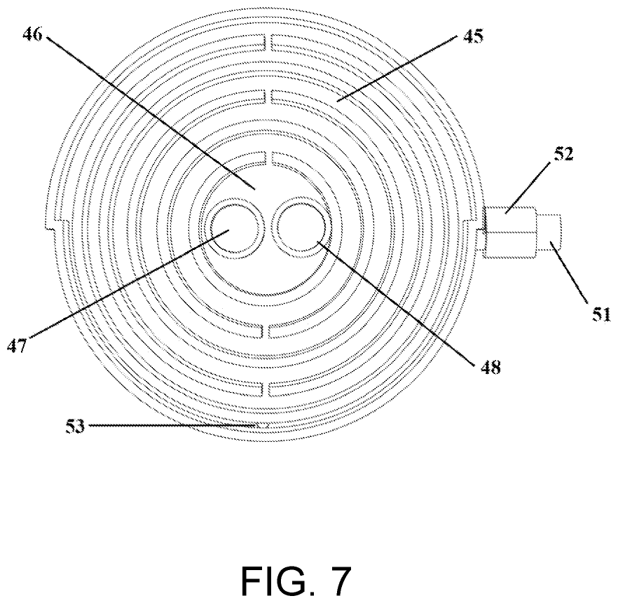

As shown in FIGS. 1-7, the heat recovery system for hydrogen production with a solid oxide electrolysis cell of the present disclosure includes a water storage tank 1, a solar cell panel 3, a low-temperature metal hydrogen storage tank 5, an evaporator 7, a high-temperature metal hydrogen storage tank 9, a heat exchanger 11, a solid oxide electrolysis cell 13, a separator 14, and a reactor 19. The water in the water storage tank 1 is pumped into a cooling plate behind the solar cell panel 3 through a water pump 2, and primary heating of water is completed after heat exchange. The present disclosure uses the waste heat generated by the solar cell panel 3 to generate electricity for heating, which not only reduces the temperature of a photovoltaic cell and improves the power generation efficiency, but also preheats the normal temperature water. Then the water flows into a liquid water inlet 21 of the low-temperature metal hydrogen storage tank 5 through a valve 4, exchanges heat with a metal hydrogen storage microtube 22 in a water flow baffle channel formed by a plurality of partition plates 123, and flows out from a liquid water outlet 26, to complete the secondary heating of water. Then the water further flows into a cold fluid inlet 36 of the evaporator 7. Due to the action of capillary force in a heat exchange cavity 37, a small amount of water is sucked into a porous water absorption layer 40, the porous water absorption layer 40 exchanges heat with a heat flow pipe 41 to realize the rapid evaporation of liquid water, and the water vapor flows out from a water vapor discharge port 43 to complete the tertiary heating of water. Under the action of a gas pump 6, the water enters from a water vapor inlet 30 of the high-temperature metal hydrogen storage tank 9, exchanges heat with a metal hydrogen storage tube 65 of a pin rib 31 on the outer tube wall in the heat exchange chamber, and flows out from a water vapor outlet 35 to complete four-stage heating. Finally, the water enters a shell-and-tube heat exchanger 11 for heat exchange to complete five-stage heating. At this time, the water vapor reaches the working temperature (800° C.) of the solid oxide electrolysis cell, flows in from the water vapor inlet of the solid oxide electrolysis cell 13, and participates in the electrochemical reaction to generate oxygen and hydrogen. Oxygen flows out from an anode product outlet of the solid oxide electrolysis cell 13 and flows into an oxygen storage tank 15. Hydrogen and unused water vapor flow out from a cathode product outlet of the solid oxide electrolysis cell 13, first pass through the shell-and-tube heat exchanger 11 for heat exchange with the to-be-reacted water vapor, and then enter the separator 14. The separator 14 has three outlets, namely a hydrogen outlet I 18, a hydrogen outlet II 17, and a water vapor outlet 16, where the hydrogen outlet I 18 of the separator 14 is connected with the low-temperature metal hydrogen storage tank 5 and the high-temperature metal hydrogen storage tank 9, heat released in the hydrogen storage process of the hydrogen storage tank is used to heat water, the hydrogen outlet II 17 of the separator 14 is connected with the reactor 19, and the hydrogen is reacted with carbon dioxide in the reactor 19 to generate methane, reaction heat of methane production is conveyed to the evaporator 7 to heat the water, the water vapor outlet 16 of the separator 14 is connected to the water storage tank 1, and the unused water vapor is returned to the water storage tank 1 through the water vapor outlet 16 of the separator 14, to complete the water recycling.

The low-temperature metal hydrogen storage tank 5 adopts at least two arrangements, one of which is used to store hydrogen and the other is for standby use. The low-temperature metal hydrogen storage tank 5 includes a heat exchange cavity I 60 and a hydrogen confluence chamber I 25, where the heat exchange cavity I 60 is provided with a plurality of partition plates I 23 arranged in parallel, the heat exchange cavity I 60 is further provided with a liquid water inlet 21 and a liquid water outlet 26, and the plurality of parallel partition plates I 23 form a baffle flow channel in the heat exchange cavity I 60. A hydrogen inlet I 24 is arranged on the hydrogen confluence chamber I 25, the hydrogen confluence chamber I 25 is communicated with a plurality of metal hydrogen storage microtubes 22, and the metal hydrogen storage microtubes 22 penetrate the entire heat exchange cavity I 60 and are filled with hydrogen storage materials. The metal hydrogen storage microtube 22 is a sandwich type casing, including an outer tube 27 and an inner tube 29 closed at one end thereof, where the inner tube 29 is a mass transfer circular tube, the outer sidewall of the inner tube 29 is longitudinally provided with a plurality of through holes 62, and a cavity 28 between the inner tube 29 and the outer tube 27 is filled with a low-temperature hydrogen storage material. The hydrogen flows into the metal hydrogen storage microtube 22 from the hydrogen confluence chamber I 25, then flows into an inner hydrogen-enhanced mass transfer circular tube 29, and finally flows into a metal hydrogen storage material 28 through the circular air holes 62 evenly distributed on the tube wall, so that the metal hydrogen storage material located between the two circular tube interlayers can fully absorb hydrogen and release heat. If the mass transfer circular tube 29 is not arranged in the metal hydrogen storage microtube 22, the hydrogen gas will be concentrated in the upper part thereof. When the mass transfer circular tube 29 is arranged, the hydrogen gas in the tube is evenly distributed. The inner tube of the metal hydrogen storage microtube 22 is an enhanced hydrogen mass transfer tube 29, and the tube wall is provided with a plurality of air holes 62. On the one hand, hydrogen can be quickly transported from the top of the metal hydrogen storage microtube to the bottom of the tube through the inner tube. In addition, hydrogen can enter the metal hydrogen storage material through the air hole 62 of the inner tube wall. The low-temperature hydrogen storage material is a hydrogen storage material of LaNi5 series, and the exothermic temperature is 60-70° C. The inner diameter of the metal hydrogen storage microtube (an outer tube) is 6 cm, and the outer diameter of an inner mass transfer circular tube (an inner tube) is 3 cm. The present disclosure cools the low-temperature metal hydrogen storage tank 5 through liquid water, which not only reduces the temperature of metal hydrogen storage, but also improves the hydrogen absorption rate, and increases the temperature of water.

The high-temperature metal hydrogen storage tank 9 adopts at least two arrangements, one of which is used to store hydrogen and the other is for standby use. The high-temperature metal hydrogen storage tank 5 includes a heat exchange cavity II 66 and a hydrogen confluence chamber II 33, where the heat exchange cavity II 66 is provided with a plurality of partition plates II 34 arranged in parallel, the heat exchange cavity II 66 is further provided with a water vapor inlet 30 and a water vapor outlet 35, and the plurality of parallel partition plates II 34 divide the heat exchange cavity II 66 into a plurality of heat exchange chambers. A hydrogen inlet II 32 is arranged on the hydrogen confluence chamber II 33, the hydrogen confluence chamber II 33 is communicated with a plurality of metal hydrogen storage tubes 65, and the outer wall of each metal hydrogen storage tube 65 is provided with a plurality of cylindrical ribs 31. The plurality of metal hydrogen storage tubes 65 penetrate the entire heat exchange cavity II 66, and the metal hydrogen storage tubes 65 are filled with high-temperature hydrogen storage materials. The metal hydrogen storage tube 65 and the metal hydrogen storage microtube 22 have the same structure, both of which are sandwich type casings, but the cavity 28 between the inner tube 29 and the outer tube 27 of the metal hydrogen storage tube 65 is filled with a high-temperature hydrogen storage material, the high-temperature hydrogen storage material is of MgH₂ series, and the exothermic temperature is 330-380° C. In the present disclosure, low-temperature and high-temperature metal hydrogen storage tanks are designed, and different metal hydrogen storage materials are adopted, to ensure the step-by-step heating of water, and to improve the heat utilization rate.

The evaporator 7 includes a heat exchange cavity 37, the heat exchange cavity 37 is provided with a cold fluid inlet 36 and a water vapor outlet 43, and a plurality of porous water absorption layers 40 are arranged in the longitudinal direction of the heat exchange cavity 37. The evaporator 7 further includes a confluence area 38 and a collector area 42 located in the heat exchange cavity 37, the inlet of the confluence area 38 is connected with an external reactor 19 through a hot fluid inlet 39, the outlet of the confluence area 38 is connected with the inlet of the collector area 42 through a plurality of heat flow pipes 41, and the outlet of the collector area 42 is connected to an external methanol storage tank 8 through a hot fluid outlet 44. The heat flow pipes 41 are arranged in the heat exchange cavity 37 along the lateral direction, and a small amount of water is sucked into the porous water absorption layer 40 under the action of capillary force (the porous water absorption layer 40 is similar to the sponge structure, but is hard, and the porosity of the porous water absorption layer 40 is 0.5). The liquid water is rapidly evaporated to form water vapor through heating of the heat flow pipe 41, and the water vapor is discharged from the water vapor outlet 43.

The reactor 19 includes a gas mixing chamber 49 and a reaction chamber 55, where the reaction chamber 55 is provided with a multi-layer reaction zone, the reaction zone is a porous catalyst layer 50, the gas mixing chamber 49 is composed of a plurality of communicated and concentric annular flow channels 45, and a hydrogen inlet 47 and a carbon dioxide inlet 48 are communicated with a central chamber 46 of the annular flow channel 45. The gas mixing chamber 49 of the annular flow channel 45 is adopted, which not only utilizes the inner space of the reactor, but also ensures the uniform mixing of the two gases. A communication hole 53 is formed at the bottom of the outermost annular flow channel 45, and the annular flow channel 45 is communicated with the reaction chamber 55 through the communication hole 53. The mixed gas flows along the annular flow channel 45, and then flows into the reaction chamber 55 from the communication hole 53. The mixed gas of hydrogen and carbon dioxide reacts at the porous catalyst layer 50, and the methane generated after the reaction at the multi-layer catalyst layer 50 flows out from a methanol outlet 51 of the reaction chamber 55. The layered arrangement of the catalyst layers 50 is conducive to sufficient reaction of the mixed gas and improves the yield of methanol.

The reactor 19 of the present disclosure adopts the gas mixing chamber 49 of the annular flow channel 45 to ensure sufficient mixing of the two gases. The reaction chamber 55 has a plurality of layered porous catalyst layers 50, and the catalyst ZnZrO is selected. The multi-layer porous catalyst layer 50 ensures that the mixed gas reacts sufficiently, and a methanol content sensor 52 is arranged at the gas outlet end so as to correct the flow rates of hydrogen and carbon dioxide in time.

According to the present disclosure, the waste heat of photovoltaic cell power generation, the heat released after hydrogen absorption by metal hydrogen storage materials, the heat of reaction between hydrogen and carbon dioxide to produce methanol, and the waste heat of tail gas of the solid oxide electrolysis cell are utilized to gradually heat the normal temperature water to the working temperature of the solid oxide electrolysis cell, thereby saving the energy consumption of traditional electric heating or fuel heating, and greatly reducing the energy consumption of the system. The hydrogen generated by this system can be directly stored in the metal hydrogen storage tank, and then transported to the hydrogen-using unit. Compared with the traditional high-pressure gas cylinder storage way, the method of the present disclosure is safer and the hydrogen storage density is higher. In addition, the system of the present disclosure uses hydrogen and carbon dioxide to prepare methanol, which not only reduces carbon dioxide emissions, but also enables production of methanol as a kind of economical fuel.

1. A heat recovery system for hydrogen production with a solid oxide electrolysis cell, comprising a water storage tank (1), a solar cell panel (3), a low-temperature metal hydrogen storage tank (5), an evaporator (7), a high-temperature metal hydrogen storage tank (9), a heat exchanger (11), a solid oxide electrolysis cell (13), a separator (14), and a reactor (19),
after water in the water storage tank (1) sequentially passes through the solar cell panel (3), the low-temperature metal hydrogen storage tank (5), the evaporator (7), the high-temperature metal hydrogen storage tank (9), and the heat exchanger (11) for multi-stage heat exchange, water vapor reaching a working temperature enters the solid oxide electrolysis cell (13),
hydrogen generated after an electrochemical reaction and the unused water vapor flow out from a cathode product outlet of the solid oxide electrolysis cell (13), firstly exchange heat with to-be-reacted water vapor through the heat exchanger (11) and then enter the separator (14),
one hydrogen outlet I (18) of the separator is connected with the low-temperature metal hydrogen storage tank (5) and the high-temperature metal hydrogen storage tank (9), and heat released in a hydrogen storage process of the hydrogen storage tank is used to heat water,
the other hydrogen outlet II (17) of the separator (14) is connected with the reactor (19), hydrogen and carbon dioxide are reacted in the reactor (19) to generate methane, and reaction heat of methane production is conveyed to the evaporator (7) to heat the water,
a water vapor outlet (16) of the separator (14) is connected with the water storage tank (1).

2. The heat recovery system for hydrogen production with the solid oxide electrolysis cell according to claim 1, wherein the low-temperature metal hydrogen storage tank (5) comprises a heat exchange cavity I (60) and a hydrogen confluence chamber I (25), wherein the heat exchange cavity I (60) is provided with a plurality of partition plates I (23) arranged in parallel, the heat exchange cavity I (60) is further provided with a liquid water inlet (21) and a liquid water outlet (26), and the plurality of parallel partition plates I (23) form a baffle flow channel in the heat exchange cavity I (60),
a hydrogen inlet I (24) is arranged on the hydrogen confluence chamber I (25), the hydrogen confluence chamber I (25) is communicated with a plurality of metal hydrogen storage microtubes (22), and the metal hydrogen storage microtubes (22) penetrate the entire heat exchange cavity I (60) and are filled with hydrogen storage materials.

3. The heat recovery system for hydrogen production with the solid oxide electrolysis cell according to claim 2, wherein the metal hydrogen storage microtube (22) is a sandwich type casing, comprising an outer tube (27) and an inner tube (29) closed at one end thereof, wherein the inner tube (29) is a mass transfer circular tube, an outer sidewall of the inner tube (29) is longitudinally provided with a plurality of through holes (62), a cavity (28) between the inner tube (29) and the outer tube (27) is filled with a low-temperature hydrogen storage material.

4. The heat recovery system for hydrogen production with the solid oxide electrolysis cell according to claim 1, wherein the high-temperature metal hydrogen storage tank comprises a heat exchange cavity II (66) and a hydrogen confluence chamber II (33), wherein the heat exchange cavity II (66) is provided with a plurality of partition plates II (34) arranged in parallel, the heat exchange cavity II (66) is further provided with a water vapor inlet (30) and a water vapor outlet (35), and the plurality of parallel partition plates II (34) partition the heat exchange chamber II (66) into a plurality of heat exchange chambers,
a hydrogen inlet II (32) is arranged on the hydrogen confluence chamber II (33), the hydrogen confluence chamber II (33) is communicated with a plurality of metal hydrogen storage tubes (65), and the outer wall of each metal hydrogen storage tube (65) is provided with a plurality of cylindrical ribs (31),
the plurality of metal hydrogen storage tubes (65) penetrate the entire heat exchange cavity II (66), and the metal hydrogen storage tubes are filled with high-temperature hydrogen storage materials.

5. The heat recovery system for hydrogen production with the solid oxide electrolysis cell according to claim 4, wherein the metal hydrogen storage tube (65) and the metal hydrogen storage microtube (22) have the same structure, both of which are sandwich type casings.

6. The heat recovery system for hydrogen production with the solid oxide electrolysis cell according to claim 1, wherein the evaporator (7) comprises a heat exchange cavity (37), the heat exchange cavity (37) is provided with a cold fluid inlet (36) and a water vapor outlet (43), and a plurality of porous water absorption layers (40) are arranged in a longitudinal direction of the heat exchange cavity (37),
the evaporator (7) further comprises a confluence area (38) and a collector area (42) located in the heat exchange cavity (37), wherein an inlet of the confluence area (38) is connected with an external reactor (19) through a hot fluid inlet (39), an outlet of the confluence area (38) is connected with an inlet of the collector area (42) through a plurality of heat flow pipes (41), and an outlet of the collector area (42) is connected to an external methanol storage tank (8) through a hot fluid outlet (44),
the heat flow pipes (41) are arranged in the heat exchange cavity (37) along a lateral direction, a small amount of water is sucked into the porous water absorption layer (40) under action of capillary force, and the porous water absorption layer (40) exchanges heat with the plurality of heat flow pipes (41).

7. The heat recovery system for hydrogen production with the solid oxide electrolysis cell according to claim 1, wherein the reactor (19) comprises a gas mixing chamber (49) and a reaction chamber (55), wherein the reaction chamber (55) is provided with a multi-layer reaction zone, the reaction zone is a porous catalyst layer (50), the gas mixing chamber (49) is composed of a plurality of communicated and concentric annular flow channels (45), and a hydrogen inlet (47) and a carbon dioxide inlet (48) are communicated with a central chamber (46) of the annular flow channel (45),
a communication hole (53) is formed at a bottom of the outermost annular flow channel (45), and the annular flow channel (45) is communicated with the reaction chamber (55) through the communication hole (53),
the mixed gas flows along the annular flow channel (45), and then flows into the reaction chamber (55) from the communication hole (53),
the mixed gas of hydrogen and carbon dioxide reacts at the porous catalyst layer (50), and the methane generated after the reaction at the multi-layer catalyst layer (50) flows out from a methanol outlet (51) of the reaction chamber (55).

8. The heat recovery system for hydrogen production with the solid oxide electrolysis cell according to claim 7, wherein a methanol content sensor (52) is arranged at the methanol outlet (51).
